(19) United States
(12) Patent Application Publication
(10) Pub. No.: US 2016/0280800 A1
(43) Pub. Date: Sep. 29, 2016

(54) RESIN COMPOSITION, METHOD OF PREPARING RESIN MOLDED ARTICLE, AND RESIN MOLDED ARTICLE

(71) Applicant: FUJI XEROX CO., LTD., Tokyo (JP)

(72) Inventor: Kenji YAO, Kanagawa (JP)

(21) Appl. No.: 14/833,520

(22) Filed: Aug. 24, 2015

(30) Foreign Application Priority Data
Mar. 26, 2015 (JP) 2015-064720

(51) Int. Cl. C08B 3/06; C08J 5/00

(52) U.S. Cl. CPC C08B 3/06; C08J 5/00; C08J 2301/12

(57) ABSTRACT

A resin composition includes a cellulose derivative, wherein a water absorption warp amount after a D2 test specimen obtained by injection-molding the resin composition using a mold of JIS type D2 regulated in JIS7152-3 (2005) is maintained for 24 hours on an aluminum plate in an environment of a temperature of 65° C. and a humidity of 85% RH is 0.3 mm or lower.

### CROSS-REFERENCE TO RELATED APPLICATIONS

This application is based on and claims priority under 35 USC 119 from Japanese Patent Application No. 2015-064720 filed Mar. 26, 2015.

### BACKGROUND

1. Technical Field

The invention relates to a resin composition, a method of preparing a resin molded article, and a resin molded article.

2. Related Art

In the related art, various resin compositions are provided to be used for various applications. Particularly, thermoplastic resins are used in various components and housings of home appliances or automobiles, or in components such as housings of business machines and electric and electronic apparatuses.

Recently, resins derived from plants are used, and a cellulose derivative is one of the resins derived from plants which are well-known so far.

### SUMMARY

According to an aspect of the invention, there is provided a resin composition including:

a cellulose derivative,

wherein a water absorption warp amount after a D2 test specimen obtained by injection-molding the resin composition using a mold of JIS type D2 regulated in JIS7152-3 (2005) is maintained for 24 hours on an aluminum plate in an environment of a temperature of 65° C. and a humidity of 85% RH is 0.3 mm or lower.

### DETAILED DESCRIPTION

Hereinafter, exemplary embodiments which are an example of the invention are described. These exemplary embodiments and examples exemplify the invention, and do not intend to limit the scope of the invention.

When amounts of respective components in a composition are described in the specification, and if plural kinds of materials corresponding to respective components exist in the composition, the amounts mean total amounts of the plural kinds of materials existing in the component, unless described otherwise.

Resin Composition

The resin composition according to the exemplary embodiment includes a cellulose derivative in which at least a portion of a hydroxyl group in a cellulose resin is substituted. In addition, in the resin composition according to the exemplary embodiment, a water absorption warp amount after a D2 test specimen obtained by injection-molding a resin composition using a mold of JIS type D2 regulated in JIS7152-3 (2005) is maintained for 24 hours on an aluminum plate in an environment of a temperature of 65° C. and a humidity of 85% RH (hereinafter, also simply referred to as “water absorption warp amount”) becomes 0.3 mm or lower.

Here, the “cellulose derivative” according to the exemplary embodiment refers to a compound in which at least a portion of the hydroxyl group included in cellulose is substituted with a substituent.

In addition, the resin composition according to the exemplary embodiment contains a cellulose derivative as a main component. The main component refers to a component of which a content ratio (based on weight) is greatest among the respective components contained in the resin composition.

Here, a water absorption warp amount is measured as follows.

Specifically, first, the resin composition that becomes a measurement target is injection-molded at conditions of an injection speed of 50 mm/s, a maintaining pressure of 80 MPa, a filling pressure of 100 MPa, an injection time of 10 seconds, a cylinder temperature of 200° C., and a mold temperature of 40° C. by using a mold of JIS type D2 regulated in JIS7152-3 (2005), so as to obtain a D2 test specimen (test specimen: 60 mm in length, 60 mm in width, and 2 mm in thickness).

The obtained D2 test specimen is allowed to stand on an aluminum plate for 24 hours in the environment of a temperature of 65° C. and humidity of 85% RH, and lift amounts (distances from aluminum plate) at edge portions of the D2 test specimen before and after being allowed to stand in the environment are measured. With respect to each of the lift amounts obtained at respective edge portions, the lift amount before being allowed to stand in the environment is set to 0 mm, change of lift amount by being allowed to stand in the environment is calculated, and a value (maximum strain) at an edge portion at which the change of the lift amount is greatest is set to a “water absorption warp amount”.

Since the resin composition according to the exemplary embodiment contains a cellulose derivative and has a water absorption warp amount in the range described above, a resin molded article having small anisotropy of the molding shrinkage rate, compared with a case in which a water absorption warp amount is greater than the range described above, may be obtained. The reason is not clear, but the followings may be considered.

The expression “water absorption warp amount is 0.3 mm or lower” means that a water absorption amount of the D2 test specimen is almost even throughout the entire D2 test specimen.

That is, according to the exemplary embodiment, a difference of water absorption amounts between a portion having a great water absorption amount and a portion having a small water absorption amount in the D2 test specimen is small compared with a case in which a water absorption warp amount is greater than 0.3 mm. Also, in the D2 test specimen in which the difference of the water absorption amounts between the portion having the great water absorption amount and the portion having the small water absorption amount is small, water is absorbed throughout the entire D2 test specimen in an almost even state.

If water is absorbed in the D2 test specimen evenly throughout the entire D2 test specimen, the entire D2 test specimen expands in an almost even state, and thus that “warp” in D2 test specimen is unlikely to occur. As a result, a water absorption warp amount is decreased.

That is, in the D2 test specimen in which the water absorption amount is almost even throughout the entire D2 test specimen, local expansion caused by a portion having a great water absorption amount is unlikely to occur. Also, in the D2 test specimen in which that local expansion caused by a portion having a great water absorption amount is unlikely to occur, deformation caused by the local expansion is unlikely to occur. In addition, if the deformation caused by the local expansion is unlikely to occur, warp at an edge portion, which is caused since stress at a portion where deformation occurs escapes to the edge portion, is unlikely to occur and thus the water absorption warp amount is decreased.

As a reason that the water absorption amount of the D2 test specimen becomes almost even throughout the entire D2 test specimen, the orientation of molecular chains of the cellulose derivative in an irregular (also referred to as “random”) state may be considered. Also, if a resin molded article is formed by using the resin composition in which the molecular chains of the cellulose derivative in the D2 test specimen are oriented in the random state, it is considered that the orientation of the molecular chain at the time of molding is almost random.

Specifically, it is generally known that a phenomenon in which the molecular chains of the resin are oriented in an injection direction (MD direction) may occur, if a resin molded article is formed by injection-molding the resin composition. However, it is considered that, in the resin composition in which the orientation of the molecular chains in the cellulose derivative of the D2 test specimen is random, a phenomenon in which the molecular chains of the cellulose derivative are oriented in the injection direction is unlikely occur at the time of injection molding. Therefore, if the resin composition in which the orientation of the molecular chains in the cellulose derivative of the D2 test specimen is random is used, it is considered that the orientation of the molecular chain at the time of molding becomes almost random.

Also, it is considered that, if the orientation of the molecular chains in the cellulose derivative at the time of molding is in the random state, shrinkage at the time of molding easily occurs in an isotropic manner, and the anisotropy of the molding shrinkage rate is decreased.

Specifically, it is considered that, if molecular chains are oriented in the injection direction (MD direction) at the time of molding, shrinkage easily occurs in a direction (TD direction perpendicular to MD direction) perpendicular to the molecular chains, and shrinkage is unlikely to occur in a direction of the molecular chains (MD direction). In this manner, if shrinkage rates are different depending on directions, the difference between a dimension of the resin molded article obtained as a result and a dimension of a hollow in the mold varies depending on directions, and thus anisotropy of the molding shrinkage rate is increased.

On the contrary, it is considered that, if the orientation of the molecular chains at the time of molding is random, the difference between the shrinkage rates depending on directions is decreased, and thus anisotropy of the molding shrinkage rate is decreased.

For the reasons described above, it is assumed that, according to the exemplary embodiment in which the water absorption warp amount is 0.3 mm or lower, a resin molded article having small anisotropy of the molding shrinkage rate compared with a case in which the water absorption warp amount is greater than 0.3 mm may be obtained.

Hereinafter, components of the resin composition according to the exemplary embodiment are described in detail.

Cellulose Derivatives

The resin composition according to the exemplary embodiment contains a cellulose derivative in which at least a portion of the hydroxyl group in the cellulose resin is substituted.

The cellulose derivative is a compound in which at least a portion of a hydroxyl group in a cellulose resin is substituted, and the cellulose derivative is not particularly limited, as long as the water absorption warp amount in the resin composition containing the cellulose derivative is 0.3 mm or lower.

As a specific example of the cellulose derivative in which the water absorption warp amount in the resin composition containing the cellulose derivative becomes 0.3 mm or lower, for example, a cellulose derivative in which the weight average molecular weight is 10,000 or greater and less than 75,000 is included.

Hereinafter, the cellulose derivative (hereinafter, also referred to as “specific cellulose derivative”) in which the weight average molecular weight is 10,000 or greater and less than 75,000 is described in detail.

Weight Average Molecular Weight

In the specific cellulose derivative used in the exemplary embodiment, the weight average molecular weight is 10,000 or greater and less than 75,000. The weight average molecular weight is preferably in the range of 20,000 to 50,000.

Since the weight average molecular weight is 10,000 or greater and less than 75,000, the anisotropy of the molding shrinkage rate is small. The reason thereof is not clear, but it is assumed that, if the weight average molecular weight is in the range described above, the molecular chains are appropriately shortened compared with a case in which the weight average molecular weight is out of the range described above, and thus the molecular chains are randomly oriented easily at the time of molding.

Here, the weight average molecular weight (Mw) is a value measured by gel permeation chromatography (GPC).

Specifically, the molecular weight by GPC is measured with a GPC apparatus (manufactured by Tosoh corporation, HLC-8320GPC, Column: TSKgel α-M) by using a solution of dimethylacetamide/lithium chloride having a volume ratio of 90/10.

Structures

As the specific cellulose derivative, for example, a compound in which at least one hydroxyl group included in cellulose is substituted with an acyl group is preferable, and specifically, for example, the cellulose derivative represented by the formula (1) is included.

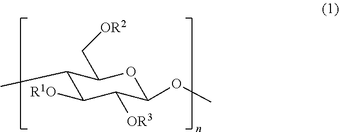

In the formula (1), R¹, R², and R³ each independently represent a hydrogen atom or an acyl group having 1 to 6 carbon atoms. n represents an integer of 2 or greater. However, at least one of plural R¹s, plural R²s, and plural R³s represents an acyl group having 1 to 6 carbon atoms.

If plural acyl groups exist among compounds represented by the formula (1), the respective acyl groups may be identical to each other, portions thereof may be identical to each other, and the respective acyl groups may be different from each other.

In the formula (1), a scope of n is not particularly limited, and is preferably in the range of 250 to 750, and more preferably in the range of 350 to 600.

If n is 250 or greater, the strength of the resin molded article is easily increased. If n is 750 or lower, the decrease in flexibility of the resin molded article is easily prevented.

Acyl Group

With respect to the cellulose derivative having the structure represented by the formula (1), at least one of plural R¹s, plural R²s, and plural R³s represents an acyl group having 1 to 6 carbon atoms.

Plural R¹s in the cellulose derivative represented by the formula (1) all may be identical to each other, may be partially identical to each other, or may be different from each other. In the same manner, plural R²s and plural R³s all may be identical to each other, may be partially identical to each other, or may be different from each other, respectively. At least one of them represents an acyl group having 1 to 6 carbon atoms.

As described above, the specific cellulose derivative preferably has an acyl group having 1 to 6 carbon atoms. If the specific cellulose derivative has an acyl group having 1 to 6 carbon atoms, compared with a case in which the number of carbon atoms in the acyl group is 7 or greater without exception, stress relaxation becomes in an appropriate range, the intermolecular force is maintained to a certain extent, and thus the anisotropy of the molding shrinkage rate becomes small.

The number of carbon atoms in the acyl group included in the specific cellulose derivative is preferably in the range of 1 to 4, and more preferably in the range of 1 to 3.

The acyl group having 1 to 6 carbon atoms is represented by a structure of “—CO—R_{AC}”, and “R_{AC}” represents a hydrogen atom or a hydrocarbon group having 1 to 5 carbon atoms.

The hydrocarbon group represented by “R_{AC}” may have any one of a straight chain shape, a branched shape, or a cyclic shape, but preferably a straight chain shape.

In addition, the hydrocarbon group may be a saturated hydrocarbon group or an unsaturated hydrocarbon group, but preferably a saturated hydrocarbon group.

In addition, the hydrocarbon group may contain other atoms (for example, oxygen or nitrogen) than carbon or hydrogen, but preferably may be a hydrocarbon group made of only carbon and hydrogen.

As the acyl group having 1 to 6 carbon atoms, a formyl group, an acetyl group, a propionyl group, a butyryl group (butanoyl group), a propenoyl group, a hexanoyl group, and the like are included.

Among them, as an acyl group, in view of reducing anisotropy of a molding shrinkage rate and the enhancement of the moldability of the resin composition, an acetyl group is preferable.

Substitution Degree

The substitution degree of the specific cellulose derivative is preferably in the range of 1.8 to 2.5. Further, the substitution degree is more preferably in the range of 2 to 2.5, and still more preferably in the range of 2.2 to 2.5.

If the substitution degree is in the range of 1.8 to 2.5, anisotropy of the molding shrinkage rate is small, compared with a case in which the substitution degree is less than 1.8 or greater than 2.5. The reason is not clear, but it is assumed that, if the substitution degree is in the range of 1.8 to 2.5, the hydrogen bond is weak, compared with the case in which the substitution degree is less than 1.8, the orientation of the molecular chains at the time of molding easily becomes almost random. In addition, it is assumed that, if the substitution degree is in the range of 1.8 to 2.5, packing of molecular chains is unlikely to occur compared with a case in which the substitution degree is greater than 2.5, and the orientation of the molecular chains at the time of molding easily becomes random in the same manner.

In addition, the substitution degree is an index indicating the degree at which the hydroxyl group included in cellulose is substituted with the substituent. As described above, if the substituent is an acyl group, the substitution degree is an index indicating a degree of acylation of a cellulose derivative. Specifically, the substitution degree means an intramolecular average of the number of substitutions of hydroxy groups, which are substituted with an acyl group, among three hydroxyl groups included in a D-glucopyranose unit of the cellulose derivative.

Synthesis Method

A method of preparing the cellulose derivative used in the exemplary embodiment is not particularly limited, and well-known methods are employed.

Hereinafter, a method of preparing a cellulose derivative in which the weight average molecular weight is 10,000 or greater and less than 75,000 and at least one hydroxyl group of the cellulose is substituted with an acyl group having 1 to 6 carbon atoms is described.

Adjustment of Molecular Weight of Cellulose

First, cellulose before acylation, that is, cellulose of which a hydroxyl group is not substituted with an acyl group, is prepared and the molecular weight thereof is adjusted.

As the cellulose before acylation, cellulose prepared arbitrarily may be used or commercially available cellulose may be used. Incidentally, the cellulose is usually a resin derived from plants, and the weight average molecular weight thereof is generally higher than that of the specific cellulose derivative according to the exemplary embodiment. Therefore, the adjustment of the molecular weight of the cellulose generally includes a step for decreasing the molecular weight.

For example, the weight average molecular weight of the commercially available cellulose is generally in the range of 150,000 to 500,000.

As the commercially available cellulose before acylation, for example, KC Flock (W50, W100, W200, W300G, W400G, W-100F, W60MG, W-50GK, and W-100GK) NDPT, NDPS, LNDP, and NSPP-HR manufactured by Nippon Paper Industries Co., Ltd. are included.

A method of adjusting a molecular weight of the cellulose before acylation is not particularly limited, but for example, there is a method of decreasing the molecular weight by stirring the cellulose in liquid.

By adjusting the speed and the time for the stirring of the cellulose is stirred, the molecular weight of the cellulose may be adjusted to a required value. In addition, though not particularly limited, the stirring speed when the cellulose is stirred is preferably in the range of 50 rpm to 3,000 rpm, and more preferably in the range of 100 rpm to 1,000 rpm. In addition, the stirring time is preferably in the range of 2 hours to 48 hours, and more preferably in the range of 5 hours to 24 hours.

In addition, as the liquid used when the cellulose is stirred, an aqueous solution of hydrochloric acid, an aqueous solution of formic acid, an aqueous solution of acetic acid, an aqueous solution of nitric acid, and an aqueous solution of sulfuric acid are exemplified.

Preparation of Cellulose Derivative

The cellulose of which the molecular weight is adjusted by the methods described above is acylated with an acyl group having 1 to 6 carbon atoms by a well-known method, to thereby obtain a cellulose derivative.

For example, for the case where at least one hydroxyl group included in the cellulose is substituted with an acetyl group, a method of esterifying the cellulose by using the mixture of acetic acid, acetic anhydride, and sulfuric acid is exemplified. In addition, for the case where at least one hydroxyl group included in the cellulose is substituted with a propionyl group, a method of performing esterification by using propionic anhydride in substitution for the acetic anhydride of the mixture is exemplified, for the case where at least one hydroxyl group included in the cellulose is substituted with a butanoyl group, a method of performing esterification by using butyric anhydride in substitution for the acetic anhydride of the mixture is exemplified, and for the case where at least one the hydroxyl group included in the cellulose is substituted with a hexanoyl group, a method of performing esterification by using hexanoic anhydride in substitution for the acetic anhydride of the mixture is exemplified.

After acylation, in order to adjust the substitution degree, a deacylation step may be further performed. In addition, after the acylation step or the deacylation step, a step of further refining the cellulose may be preformed.

Ratio Occupied in Resin Composition

In the resin composition according to the exemplary embodiment, in order to cause the function of the cellulose derivative to be easily revealed, a ratio occupied by the cellulose derivative with respect to the total amount of the resin composition is preferably 70% by weight or greater, more preferably 80% by weight or greater, and may be 100% by weight.

If the ratio is 70% by weight or greater, a resin molded article having small anisotropy of the molding shrinkage rate may be easily obtained. The reason is not clear, but it is assumed as follows.

If the content of the cellulose derivative is in the range described above, a ratio of components other than the cellulose derivative (hereinafter, referred to as “other components”) is small, compared with the case in which the content is less than the range described above. If the ratio of the other components is small, an area in which the other components are unevenly distributed is unlikely to form, compared with a case in which the ratio of the other components is too large, and thus it is unlikely that the area in which the other components are unevenly distributed locally shrinks at a different shrinkage rate at the time of molding. Also, since it is unlikely that a specific area locally shrinks at a different shrinkage rate at the time of molding, the increase in the anisotropy of the molding shrinkage rate caused by the local shrinkage at a different shrinkage rate is unlikely to occur, and, as a result, it is assumed that anisotropy of the molding shrinkage rate is decreased.

For the reasons described above, if the content of the cellulose derivative is in the range described above, it is assumed that a resin molded article having small anisotropy of the molding shrinkage rate compared with a case in which the content is smaller than the range described above may be obtained.

Plasticizer

The resin composition according to the exemplary embodiment may further contain a plasticizer.

In addition, the content of the plasticizer is such an amount that the ratio of the cellulose derivative occupied in the total amount of the resin composition becomes the range described above. More specifically, the ratio of the plasticizer with respect to the total amount of the resin composition is preferably 15% by weight or lower, more preferably 10% by weight or lower, and still more preferably 5% by weight or lower. If the ratio of the plasticizer is in the range described above, an elastic modulus becomes higher, and thus heat resistance becomes higher as well. In addition, bleeding of the plasticizer is prevented.

For example, as the plasticizer, an adipic acid ester-containing compound, a polyether ester compound, a sebacic acid ester compound, a glycol ester compound, an acetic acid ester, a dibasic acid ester compound, a phosphoric acid ester compound, a phthalic acid ester compound, camphor, citric acid ester, stearic acid ester, metallic soap, polyol, polyalkylene oxide, and the like are exemplified.

Among these, an adipic acid ester-containing compound, and a polyether ester compound are preferable, and an adipic acid ester-containing compound is more preferable.

Adipic Acid Ester-Containing Compound

An adipic acid ester-containing compound (compound containing adipic acid ester) refers to a compound of individual adipic acid esters, and a mixture of adipic acid ester and components other than adipic acid ester (compound different from adipic acid ester). However, the adipic acid ester-containing compound may preferably contain the adipic acid ester by 50% by weight or more with respect to the total of adipic acid ester and other components.

As the adipic acid ester, for example, adipic acid diester, and adipic acid polyester are exemplified. Specifically, adipic acid diester represented by the formula (2-1) and adipic acid polyester represented by the formula (2-2) are exemplified.

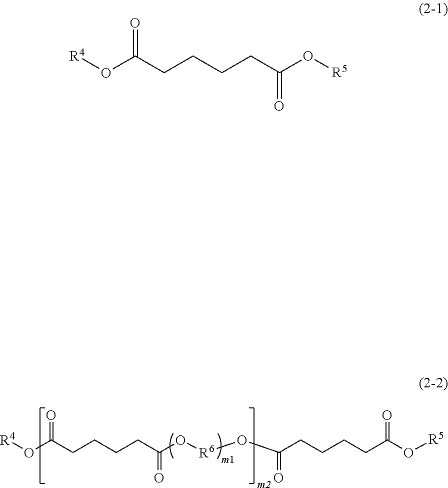

In the formulae (2-1) and (2-2), R⁴ and R⁵ each independently represents an alkyl group, or a polyoxyalkyl group [—(C)ₓH_{2X}—O)_{y}—R^{A1}] (provided that R^{A1} represents an alkyl group, x represents an integer in the range of 1 to 10, and y represents an integer in the range of 1 to 10.)

R⁶ represents an alkylene group.

m1 represents an integer in the range of 1 to 20.

m2 represents an integer in the range of 1 to 10.

In the formulae (2-1) and (2-2), the alkyl groups represented by R⁴ and R⁵ are preferably alkyl groups having 1 to 6 carbon atoms, and more preferably alkyl groups having 1 to 4 carbon atoms. The alkyl groups represented by R⁴ and R⁵ may have any one of a linear shape, a branched shape, or a cyclic shape, but preferably a linear shape and a branched shape.

In the formulae (2-1) and (2-2), in the polyoxyalkyl group represented by R⁴ and R⁵ [—(CₓH_{2X}—O)_{y}—R^{A1}], the alkyl group represented by R^{A1} is preferably an alkyl group having 1 to 6 carbon atoms, and more preferably an alkyl group having 1 to 4 carbon atoms. The alkyl group represented by R^{A1} may have any one of a linear shape, a branched shape, or a cyclic shape, but preferably a linear shape and a branched shape.

In the formula (2-2), the alkylene group represented by R⁶ is preferably an alkylene group having 1 to 6 carbon atoms, and more preferably an alkylene group having 1 to 4 carbon atoms. The alkylene group represented by R⁶ may have any one of a linear shape, a branched shape, or a cyclic shape, but preferably a linear shape and a branched shape.

In the formulae (2-1) and (2-2), the group represented by each of R⁴ to R⁶ may be substituted with a substituent. As the substituent, an alkyl group, an aryl group, and a hydroxyl group are exemplified.

The molecular weight of the adipic acid ester (or weight average molecular weight) is preferably in the range of 200 to 5,000, and more preferably in the range of 300 to 2,000. The weight average molecular weight is a value measured according to the method of measuring the weight average molecular weight of the cellulose derivative described above.

Specific examples of the adipic acid ester-containing compound are described below, but the invention is not limited thereto.

| | Name of Material | Name of Product | Manufacturer |
|---|---|---|---|
| ADP1 | Adipic acid diester | Daifatty 101 | Daihachi Chemical |
| | | | Industry Co., Ltd. |
| ADP2 | Adipic acid diester | Adeka Cizer | ADEKA Corporation |
| | | RS-107 | |
| ADP3 | Adipic acid | Polycizer | DIC Corporation |
| | polyester | W-230-H | |

Polyether Ester Compound

As the polyether ester compound, or example, a polyether ester compound represented by the formula (2) is exemplified.

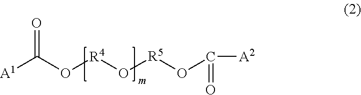

In the formula (2), R⁴ and R⁵ each independently represents an alkylene group having 2 to 10 carbon atoms. A¹ and A² each independently represents an alkyl group having 1 to 6 carbon atoms, an aryl group having 6 to 12 carbon atoms, or an aralkyl group having 7 to 18 carbon atoms. m represents an integer of 1 or greater.

In the formula (2), as the alkylene group represented by R⁴, an alkylene group having 3 to 10 carbon atoms is preferable, and an alkylene group having 3 to 6 carbon atoms is more preferable. The alkylene group represented by R⁴ may have any one of a linear shape, a branched shape, or a cyclic shape, but preferably a linear shape.

If the number of carbons of the alkylene group represented by R⁴ is set to be 3 or greater, the decrease of the fluidity of the resin composition is prevented, and thermoplasticity is easily exhibited. If the number of carbons of the alkylene group represented by R⁴ is 10 or lower, or the alkylene group represented by R⁴ has a linear shape, the affinity to the cellulose derivative is easily enhanced. Therefore, if the alkylene group represented by R⁴ has a linear shape, and the number of carbons is in the range described above, moldability of the resin composition is enhanced.

In this point of view, particularly, the alkylene group represented by R⁴ is preferably a n-hexylene group (—(CH₂)₆—). That is, the polyether ester compound is preferably a compound where R⁴ represents a n-hexylene group (—(CH₂)₆—).

In the formula (2), as the alkylene group represented by R⁵, an alkylene group having 3 to 10 carbon atoms is preferable, and an alkylene group having 3 to 6 carbon atoms is more preferable. The alkylene group represented by R⁵ may have any one of a linear shape, a branched shape, or a cyclic shape, but preferably a linear shape.

If the number of carbons of the alkylene group represented by R⁵ is 3 or greater, the decrease of the fluidity of the resin composition is prevented, and the thermoplasticity is easily exhibited. If the number of carbons of the alkylene group represented by R⁵ is 10 or lower, or if the alkylene group represented by R⁵ has a linear shape, the affinity to the cellulose derivative is easily enhanced. Therefore, if the alkylene group represented by R⁵ has a linear shape, and the number of carbons is in the range described above, moldability of the resin composition is enhanced.

In this point of view, particularly, the alkylene group represented by R⁵ is preferably a n-butylene group (—(CH₂)₄—). That is, the polyether ester compound is preferably a compound where R⁵ represents a n-butylene group (—(CH₂)₄—).

In the formula (2), the alkyl groups represented by A¹ and A² are alkyl groups having 1 to 6 carbon atoms, and alkyl groups having 2 to 4 carbon atoms are more preferable. The alkyl groups represented by A¹ and A² may have any one of a linear shape, a branched shape, or a cyclic shape, but preferably a branched shape.

The aryl groups represented by A¹ and A² are aryl groups having 6 to 12 carbon atoms, and as examples thereof, an unsubstituted aryl group such as a phenyl group and a naphthyl group or a substituted phenyl group such as a t-butylphenyl group and a hydroxyphenyl group are exemplified.

The aralkyl group represented by A¹ and A² is a group represented by —R^{A}-Ph. R^{A} represents a linear-shaped or branched alkylene group having 1 to 6 carbon atoms (preferably, having 2 to 4 carbon atoms). Ph represents an unsubstituted phenyl group or a substituted phenyl group which is substituted with the linear-shaped or branched alkyl group having 1 to 6 carbon atoms (preferably, having 2 to 6 carbon atoms). As the aralkyl group, specifically, for example, an unsubstituted aralkyl group such as a benzil group, a phenylmethyl group (phenethyl group), a phenylpropyl group, and a phenylbutyl group, and a substituted aralkyl group such as a methylbenzil group, a dimethylbenzil group, and a methylphenethyl group are exemplified.

At least one of A¹ and A² preferably represents an aryl group or an aralkyl group. That is, the polyether ester compound is preferably a compound where at least one of A¹ and A² represents an aryl group (preferably, phenyl group) or an aralkyl group, and preferably a compound where both of A¹ and A² represent an aryl group (preferably, phenyl group) or an aralkyl group.

Subsequently, characteristics of the polyether ester compound are described.

The weight average molecular weight (Mw) of the polyether ester compound is preferably in the range of 450 to 650, and more preferably in the range of 500 to 600.

If the weight average molecular weight (Mw) is 450 or greater, bleeding (phenomenon of deposition) becomes difficult. If the weight average molecular weight (Mw) is 650 or lower, the affinity to the cellulose derivative is easily enhanced. Therefore, if the weight average molecular weight (Mw) is in the range described above, moldability of the resin composition is enhanced.

In addition, the weight average molecular weight (Mw) of the polyether ester compound is a value measured by gel permeation chromatography (GPC). Specifically, the measurement of the molecular weight by GPC is performed by using HPLC1100 manufactured by Tosoh corporation as a measurement apparatus, and TSKgel GMHHR-M+TSKgel GMHHR-M (7.8 mm I.D. 30 cm) which is a column manufactured by Tosoh Corporation, with a chloroform solvent. Also, the weight average molecular weight is calculated by using a molecular weight calibration curve obtained by a monodispersed polystyrene standard sample from the measurement result.

The viscosity of the polyether ester compound at 25° C. is preferably in the range of 35 mPa·s to 50 mPa·s, and more preferably in the range of 40 mPa·s to 45 mPa·s.

If the viscosity is 35 mPa·s or greater, the dispersibility to the cellulose derivative is easily enhanced. If the viscosity is 50 mPa·s or lower, anisotropy of the dispersion of the polyether ester compound hardly appears. Therefore, if the viscosity is in the range described above, the moldability of the resin composition is enhanced.

In addition, the viscosity is a value measured by an E-type viscosmeter.

A solubility parameter (SP value) of the polyether ester compound is preferably in the range of 9.5 to 9.9, and more preferably in the range of 9.6 to 9.8.

If the solubility parameter (SP value) is in the range of 9.5 to 9.9, dispersibility to the cellulose derivative is easily enhanced.

The solubility parameter (SP value) is a value calculated by a Fedor method, and specifically, the solubility parameter (SP value) is, for example, calculated by the following equation in conformity with the description in Polym. Eng. Sci., vol. 14, p. 147 (1974).

SP value=√(Ev/v)=√(ΣΔei/ΣΔvi) Equation:

(In the equation, Ev: evaporation energy (cal/mol), v: molar volume (cm³/mol), Δei: evaporation energy of each atom or atom group, and Δvi: molar volume of each atom or atom group)

In addition, the solubility parameter (SP value) employs (cal/cm³)^{1/2} as a unit, but the unit is omitted in conformity with practice, and is described in a dimensionless manner.

Hereinafter, specific examples of the polyether ester compound are described, but the invention is not limited thereto.

| | | | | | | Viscosity | | |
|---|---|---|---|---|---|---|---|---|
| | R⁴ | R⁵ | A¹ | A² | Mw | (25° C.) | APHA | SP value |
| PEE1 | —(CH₂)₆— | —(CH₂)₄— | Phenyl group | Phenyl group | 550 | 43 | 120 | 9.7 |
| PEE2 | —(CH₂)₂— | —(CH₂)₄— | Phenyl group | Phenyl group | 570 | 44 | 115 | 9.4 |
| PEE3 | —(CH₂)₁₀— | —(CH₂)₄— | Phenyl group | Phenyl group | 520 | 48 | 110 | 10.0 |
| PEE4 | —(CH₂)₆— | —(CH₂)₂— | Phenyl group | Phenyl group | 550 | 43 | 115 | 9.3 |
| PEE5 | —(CH₂)₆— | —(CH₂)₁₀— | Phenyl group | Phenyl group | 540 | 45 | 115 | 10.1 |
| PEE6 | —(CH₂)₆— | —(CH₂)₄— | t-Butyl group | t-Butyl group | 520 | 44 | 130 | 9.7 |
| PEE7 | —(CH₂)₆— | —(CH₂)₄— | Phenyl group | Phenyl group | 460 | 45 | 125 | 9.7 |
| PEE8 | —(CH₂)₆— | —(CH₂)₄— | Phenyl group | Phenyl group | 630 | 40 | 120 | 9.7 |
| PEE9 | —(CH₂)₆— | —(CH₂)₄— | Phenyl group | Phenyl group | 420 | 43 | 135 | 9.7 |
| PEE10 | —(CH₂)₆— | —(CH₂)₄— | Phenyl group | Phenyl group | 670 | 48 | 105 | 9.7 |
| PEE11 | —(CH₂)₆— | —(CH₂)₄— | Phenyl group | Phenyl group | 550 | 35 | 130 | 9.7 |
| PEE12 | —(CH₂)₆— | —(CH₂)₄— | Phenyl group | Phenyl group | 550 | 49 | 125 | 9.7 |
| PEE13 | —(CH₂)₆— | —(CH₂)₄— | Phenyl group | Phenyl group | 550 | 32 | 120 | 9.7 |
| PEE14 | —(CH₂)₆— | —(CH₂)₄— | Phenyl group | Phenyl group | 550 | 53 | 105 | 9.7 |
| PEE15 | —(CH₂)₆— | —(CH₂)₄— | Phenyl group | Phenyl group | 550 | 43 | 135 | 9.7 |
| PEE16 | —(CH₂)₆— | —(CH₂)₄— | Phenyl group | Phenyl group | 550 | 43 | 105 | 9.7 |
| PEE17 | —(CH₂)₆— | —(CH₂)₄— | Phenyl group | Phenyl group | 550 | 43 | 150 | 9.7 |
| PEE18 | —(CH₂)₆— | —(CH₂)₄— | Phenyl group | Phenyl group | 550 | 43 | 95 | 9.7 |

Other Components

The resin composition according to the exemplary embodiment may contain other components in addition to the components described above, if necessary. As the other components, for example, a flame retardant, a compatibilizer, an antioxidant, a release agent, a light resistant agent, a weather resistant agent, a colorant, pigments, a modifier, a drip preventing agent, an antistatic agent, a hydrolysis inhibitor, a filler, and a reinforcing agent (glass fiber, carbon fiber, talc, clay, mica, glass flake, milled glass, glass bead, crystalline silica, alumina, silicon nitride, aluminum nitride, boron nitride, and the like) are exemplified. The content of the respective components is in the range of 0% by weight to 5% by weight with respect to the total amount of the resin composition. Here, the expression “0% by weight” means not including other components.

The resin composition according to the exemplary embodiment may contain other resins in addition to the resin described above. However, the other resins are included in amounts with which the ratio of the cellulose derivative occupied in the total amount of the resin composition becomes in the range described above.

As the other resins, for example, the thermoplastic resins which are well-known in the art are included. Specifically, polycarbonate resin; polypropylene resin; polyester resin; a polyolefin resin; polyester carbonate resin; a polyphenylene ether resin; polyphenylene sulfide resin; a polysulfone resin; polyether sulfone resin; a polyarylene resin; a polyetherimide resin; a polyacetal resin; a polyvinyl acetal resin; a polyketone resin; a polyetherketone resin; a polyetheretherketone resin; a polyarylketone resin; a polyether nitrile resin; a liquid crystal resin; a polybenzimidazole resin; polyparabanic acid resin; a vinyl-based polymer or a vinyl-based copolymer resin obtained by polymerizing or copolymerizing one or more vinyl monomers selected from the group consisting of an aromatic alkenyl compound, a methacrylic acid ester, acrylic acid ester, and a vinyl cyanide compound; a diene-aromatic alkenyl compound copolymer resin; a vinyl cyanide-diene-aromatic alkenyl compound copolymer resin; an aromatic alkenyl compound-diene-vinyl cyanide-N-phenylmaleimide copolymer resin; a vinyl cyanide-(ethylene-diene-propylene (EPDM))-aromatic alkenyl compound copolymer resin; a vinyl chloride resin; and a chlorinated vinyl chloride resin are exemplified. These resins may be used singly, or two or more types thereof may be used in combination.

Method of Preparing Resin Composition

The resin composition according to the exemplary embodiment is prepared, for example, by melting and kneading the mixture of the cellulose derivative and the components described above. In addition, the resin composition according to the exemplary embodiment is prepared by dissolving the components in a solvent. As a melting and kneading unit, well known units are included, and specifically, for example, a twin screw extruder, a Henschel mixer, a Banbury mixer, a single screw extruder, a multi-screw extruder, and a co-kneader are included.

In addition, the temperature at the time of kneading may be determined according to the melting temperature of the cellulose derivative used, but in view of the thermal decomposition and the fluidity, the temperature in the range of 140° C. to 240° C. is preferable, and the temperature in the range of 160° C. to 200° C. is more preferable.

Resin Molded Article and Method of Preparing Resin Molded Article

The resin molded article according to the exemplary embodiment includes the resin composition according to the exemplary embodiment. That is, the resin molded article according to the exemplary embodiment is made of the same composition as the resin composition according to the exemplary embodiment.

Specifically, the resin molded article according to the exemplary embodiment may be obtained by molding the resin composition according to the exemplary embodiment. As the molding method, injection molding, extrusion molding, blow molding, heat press molding, calendaring molding, coating molding, cast molding, dipping molding, vacuum molding, transfer molding and the like may be applied.

The method of molding the resin molded article according to the exemplary embodiment is preferably injection molding, since a shape has a high degree of freedom.

The injection molded article which is the resin molded article obtained by injection molding may be obtained by heating and melting the resin composition, casting the resin composition into a mold, and solidifying the resin composition. The resin composition may be molded by injection compression molding.

If injection molding is applied, in an injection molding step in which the resin molded article is obtained by injection-molding the resin composition, it is preferable that the injection speed is set to be in the range of 10 mm/s to 400 mm/s, and the maintaining pressure is set to be in the range of 5 MPa to 200 MPa.

Here, the “injection speed” means a flow velocity at which the mold is filled with the resin. In addition, the “maintaining pressure” refers to a pressure which is applied after the mold is filled with the resin, in order to maintain the resin.

If the injection speed is set to be in the range described above, anisotropy of the molding shrinkage rate is decreased, compared with a case in which the injection speed is less (slower) than the range described above. The reason is not clear, but it is assumed that, if the resin composition according to the exemplary embodiment is used, in a case in which the injection speed is in the range described above, molecular chains of the cellulose derivative are unlikely to be oriented in one direction at the time of injection and the molecular chains are easily oriented in a random state, compared with a case in which the injection speed is less than the range described above.

If the general resin composition is injection-molded, it is considered that the stress is decreased by slowing the injection speed, and molecular chains easily become random. Therefore, the injection speed is set to less than 100 mm/s, in many cases. However, it is found that, in the case where the resin composition according to the exemplary embodiment is injection-molded, if the injection speed is set to be faster than in the past and is set to be in the range described above, anisotropy of the molding shrinkage rate in the obtained molded article is decreased.

In addition, if the injection speed is set to be in the range described above, a flow mark or jetting is unlikely to occur compared with a case in which the injection speed is greater (faster) than the range described above, and thus the appearance tends to become satisfactory, which is favorable.

Further, if the maintaining pressure is in the range described above, the anisotropy of the molding shrinkage rate is decreased, compared with a case in which the maintaining pressure is greater (stronger) than the range described above. The reason is not clear, but if the maintaining pressure is set to be small (weak), the molecular chains of the cellulose derivative in the mold are is unlikely to be oriented in one direction, and the molecular chains are easily oriented in a random state.

In addition, if the maintaining pressure is in the range described above, a shrinkage hole is unlikely to occur compared with a case in which the maintaining pressure is set to be smaller (weaker) than the range described above, and thus the appearance becomes satisfactory, which is favorable.

In addition, the injection speed is more preferably in the range of 20 mm/s to 300 mm/s, still more preferably in the range of 30 mm/s to 200 mm/s, particularly preferably in the range of 100 mm/s to 200 mm/s, and most preferably in the range of 140 mm/s to 180 mm/s. The maintaining pressure is more preferably in the range of 10 MPa to 170 MPa, and still more preferably in the range of 20 MPa to 150 MPa.

In addition, the filling pressure (pressure applied to fill mold with resin) is preferably in the range of 10 MPa to 300 MPa, and more preferably in the range of 20 MPa to 250 MPa. The injection time (total time of filling time during which mold is filled with resin and maintaining time during which maintaining pressure is applied) is preferably in the range of 1 second to 30 seconds, and more preferably in the range of 5 seconds to 20 seconds.

The cylinder temperature of the injection molding machine is, for example, in the range of 140° C. to 240° C., preferably in the range of 150° C. to 220° C., and more preferably in the range of 160° C. to 200° C. The mold temperature of the injection molding is, for example, in the range of 30° C. to 120° C., is preferably in the range of 40° C. to 80° C.

The injection molding may be performed, for example, by using a commercially available apparatus such as NEX150 manufactured by Nissei Plastic Industrial Co., Ltd., NEX70000 manufactured by Nissei Plastic Industrial Co., Ltd., and SE50D manufactured by Toshiba Machine Co., Ltd.

The resin molded article according to the exemplary embodiment may be appropriately used for the purposes of electric and electronic apparatuses, business machines, home appliances, automobile interior materials, engine covers, car bodies, containers, and the like. More specifically, the resin molded article may be used in housings of electric and electronic apparatuses or home appliances; various components of electric and electronic apparatuses or home appliances; interior components of automobiles; storage cases of CD-ROM, DVD, and the like; food containers; drink bottles; food trays; wrapping materials; films; and sheets.

### EXAMPLES

Hereinafter, the invention is described in greater detail with reference to examples, but the invention is not limited to the examples. In addition, unless described otherwise, the expression “part” refers to “part by weight”.

Preparation of Cellulose

2 kg of cellulose (KC Flock W50 manufactured by Nippon Paper Industries Co., Ltd.) is put to 20 L of an aqueous solution of 0.1 M hydrochloric acid, and stirred at room temperature (25° C.). In stirring time shown in Table 1, cellulose in respective molecular weights is obtained. In addition, EP-1800 (product name, manufactured by Shinto Scientific Co., Ltd.) is used as a stirring apparatus, and the rotation speed at the time of stirring is set to 500 rpm.

The weight average molecular weight is measured with a GPC apparatus (manufactured by Tosoh corporation, HLC-8320GPC, Column: TSKgel α-M), by using a solution of dimethylacetamide/lithium chloride having a volume ratio of 90/10.

TABLE 1

| | Stirring time | Weight average |
|---|---|---|
| | (hr) | molecular weight |
| Compound 1 | 0.3 | 75,500 |
| Compound 2 | 1 | 57,800 |
| Compound 3 | 2 | 31,000 |
| Compound 4 | 3 | 10,300 |
| Compound 5 | 5 | 9,400 |

Manufacturing of Cellulose Derivative

Acetylation Step

Pretreatment activation is performed by spraying 1 kg of Compound 1 in Table 1, with 500 g of glacial acetic acid. Thereafter, a mixture of 3.8 kg of glacial acetic acid, 2.4 kg of acetic anhydride, and 80 g of sulfuric acid is added, and esterification of Compound 1 is performed while the mixture is stirred and mixed at a temperature of 40° C. or lower. Esterification is finished when fiber fragments disappear.

Deacetylation Step

2 kg of acetic acid and 1 kg of water are added to the mixture, and stirred for 2 hours at room temperature (25° C.)

Refinement Step

Further, this solution is slowly dripped to a solution obtained by dissolving 20 kg of sodium hydroxide in 40 kg of water while the solution is stirred. The obtained white precipitate is suction-filtered and washed with 60 kg of water, and a cellulose derivative (Compound 6) is obtained.

Cellulose derivatives (Compounds 7 to 10) are obtained in the same manner as described above except for changing Compound 1 to Compounds 2 to 5.

A cellulose derivative (Compound 11) is obtained in the same manner as described above except for using Compound 3 performing a refinement step right after an acetylation step is finished.

Cellulose derivatives (Compounds 12 to 16) are obtained in the same manner as described above except for using Compound 3 changing stirring time in deacetylation steps to 0.5 hours, 1 hour, 3 hours, 5 hours, and 10 hours, respectively.

Cellulose derivatives (Compounds 17 to 19) are obtained in the same manner as described above except for using Compound 3 and changing 2.4 kg of acetic anhydride in an acetylation step respectively to 2 kg of propionic anhydride/0.3 kg of acetic anhydride and 1.8 kg of n-butyric anhydride/6 kg of acetic anhydride and 0.5 kg of n-hexanoic anhydride.

Weight average molecular weights are obtained in the same manner as in Compound 1, and substitution degrees are obtained with H¹-NMR measurement (JNM-ECZR manufactured by JEOL Ltd.).

The results are collectively shown in Table 2.

TABLE 2

| | Weight average | | Substitution |
|---|---|---|---|
| | molecular weight | Substituent | degree |
| Compound 6 | 79,800 | Acetyl | 2.15 |
| Compound 7 | 63,300 | Acetyl | 2.22 |
| Compound 8 | 38,800 | Acetyl | 2.25 |
| Compound 9 | 11,000 | Acetyl | 2.21 |
| Compound 10 | 9,900 | Acetyl | 2.19 |
| Compound 11 | 42,300 | Acetyl | 2.78 |
| Compound 12 | 40,500 | Acetyl | 2.59 |
| Compound 13 | 39,000 | Acetyl | 2.48 |
| Compound 14 | 37,000 | Acetyl | 1.65 |
| Compound 15 | 36,100 | Acetyl | 0.38 |
| Compound 16 | 35,800 | Acetyl | 0.25 |
| Compound 17 | 42,500 | n-propionyl/ | 2.05/0.35 |
| | | acetyl | |
| Compound 18 | 44,300 | n-butanoyl/ | 1.88/0.55 |
| | | acetyl | |
| Compound 19 | 36,000 | n-hexanoyl | 0.55 |

Cellulose Derivatives C-1 to C-6 obtained in Synthesis Examples 1 to 6 (paragraphs [0107] to [0112]) of Japanese Patent No. 5,470,032 are set to Compounds 20 to 25, respectively.

TABLE 3

| | Synthesis | | | |
|---|---|---|---|---|
| | example of | Weight | | |
| | Japanese | average | | Substi- |
| | Patent No. | molecular | | tution |
| | 5,470,032 | weight | Substituent | degree* |
| Compound 20 | C-1 | 185,000 | Methyl/propylene | 1.95/1.05 |
| | | | oxy acetyl + | |
| | | | acetyl | |
| Compound 21 | C-2 | 617,000 | Methyl/propylene | 1.84/1.16 |
| | | | oxy acetyl + | |
| | | | acetyl | |
| Compound 22 | C-3 | 770,000 | Methyl/propylene | 1.47/1.53 |
| | | | oxy acetyl + | |
| | | | acetyl | |
| Compound 23 | C-4 | 680,000 | Methyl/propylene | 1.45/1.55 |
| | | | oxy acetyl + | |
| | | | acetyl | |
| Compound 24 | C-5 | 402,000 | Methyl/propylene | 1.5/1.5 |
| | | | oxy propionyl + | |
| | | | propionyl | |
| Compound 25 | C-6 | 237,000 | Methyl/propylene | 1.43/1.57 |
| | | | oxy acetyl + | |
| | | | acetyl | |

*Substitution degree of alkyl/Sum of substitution degree of alkyleneoxyacyl and substitution degree of acyl

Preparation of Pellets

Kneading is performed with a twin screw kneading apparatus (TEX41SS manufactured by Toshiba Machine Co., Ltd.) at mixing composition ratios and kneading temperatures in Examples 1 to 23 and Comparative Examples 1 to 10 shown in Tables 4 and 5, so as to obtain resin composition pellets.

TABLE 4

| | Composition ratio | | | Kneading |
|---|---|---|---|---|
| | Cellulose derivatives | | Plasticizer | temperature |
| | (parts by weight) | | (parts by weight) | (° C.) |
| Example 1 | Compound 7 (100) | | | 200 |
| Example 2 | Compound 8 (100) | | | 190 |
| Example 3 | Compound 9 (100) | | | 180 |
| Example 4 | Compound 11 (100) | | | 180 |
| Example 5 | Compound 12 (100) | | | 190 |
| Example 6 | Compound 13 (100) | | | 190 |
| Example 7 | Compound 14 (100) | | | 190 |
| Example 8 | Compound 15 (100) | | | 200 |
| Example 9 | Compound 16 (100) | | | 200 |
| Example 10 | Compound 17 (100) | | | 160 |
| Example 11 | Compound 18 (100) | | | 160 |
| Example 12 | Compound 19 (100) | | | 170 |
| Example 13 | Compound 8 (95) | | Compound 27 (5) | 180 |
| Example 14 | Compound 8 (90) | | Compound 27 (10) | 160 |
| Example 15 | Compound 8 (85) | | Compound 27 (15) | 150 |
| Example 16 | Compound 7 (90) | Compound 26 (10) | | 220 |
| Example 17 | Compound 7 (80) | Compound 26 (20) | | 210 |
| Example 18 | Compound 7 (65) | Compound 26 (35) | | 200 |
| Example 19 | Compound 8 (90) | Compound 26 (10) | | 190 |
| Example 20 | Compound 8 (80) | Compound 26 (20) | | 190 |
| Example 21 | Compound 8 (70) | Compound 26 (30) | | 200 |
| Example 22 | Compound 7 (75) | Compound 26 (20) | Compound 27 (5) | 200 |
| Example 23 | Compound 8 (75) | Compound 26 (20) | Compound 27 (5) | 180 |

TABLE 5

| | Composition ratio | | Kneading |
|---|---|---|---|
| | Cellulose derivatives | Plasticizer | temperature |
| | (parts by weight) | (parts by weight) | (° C.) |
| Comparative | Compound 6 (100) | | 200 |
| Example 1 | | | |
| Comparative | Compound 10 (100) | | 170 |
| Example 2 | | | |
| Comparative | Compound 6 (90) | Compound 27 (10) | 180 |
| Example 3 | | | |
| Comparative | Compound 10 (90) | Compound 27 (10) | 160 |
| Example 4 | | | |
| Comparative | Compound 20 (100) | | 200 |
| Example 5 | | | |
| Comparative | Compound 21 (100) | | 205 |
| Example 6 | | | |
| Comparative | Compound 22 (100) | | 200 |
| Example 7 | | | |
| Comparative | Compound 23 (100) | | 200 |
| Example 8 | | | |
| Comparative | Compound 24 (100) | | 190 |
| Example 9 | | | |
| Comparative | Compound 25 (100) | | 190 |
| Example 10 | | | |

In addition, details of Compounds 26 and 27 shown in Tables 4 and 5 are described below.
Compound 26: Dimethyl cellulose (L50 manufactured by Daicel Corporation, weight average molecular weight: 170,000)
Compound 27: Adipic acid ester-containing compound (Daifatty101 manufactured by Daihachi Chemical Industry Co., Ltd.)

Injection Molding

With the obtained pellets, resin molded articles (length of 60 mm, width of 60 mm, and thickness of 2 mm) are prepared by using an injection molding machine (PNX40 manufactured by Nissei Plastic Industrial Co., Ltd.) under conditions of injection speed of 150 mm/s, maintaining pressure of 50 MPa, filling pressure of 120 MPa, injection time of 10 seconds, and cylinder temperatures and mold temperatures shown in Tables 6 and 7.

Measurement of Water Absorption Warp Amount

With the obtained pellets, D2 test specimens (test specimens in length of 60 mm, width of 60 mm, and thickness of 2 mm) are prepared by using the injection molding machine (PNX40 manufactured by Nissei Plastic Industrial Co., Ltd.) and the mold of JIS type D2 regulated in JIS7152-3 (2005) under conditions of an injection speed of 150 mm/s, a maintaining pressure of 50 MPa, a filling pressure of 120 MPa, an injection time of 10 seconds, a cylinder temperature of 200° C., and a mold temperature of 40° C.

The obtained D2 test specimens are placed on an aluminum plate, are put into a thermohygrostat bath (PR-1 manufactured by Espec Corp.) which is set to the environment of temperature of 65° C. and humidity of 85% RH, and are allowed to stand in the environment for 24 hours. Thereafter, the aluminum plate on which the D2 test specimens are placed is taken out, lift amounts of edge portions are measured by a laser displacement sensor (CD5 manufactured by Optex Co., Ltd), the lift amounts are compared with lift amounts before the D2 test specimens are allowed to stand in the above environment, respectively, with respect to the respective edge portions, to calculate the change in the lift amount at the respective edge portions. The value of the change (maximum strain) at the edge portion at which the change of the lift amount is greatest is set to be a “water absorption warp amount”. The results are shown in Tables 6 and 7.

Evaluation of Anisotropy of Molding Shrinkage Rate

With each of the resin molded articles obtained by injection molding, dimensions in the MD direction and the TD direction right after the molding (within 20 minutes after molding) are measured by a microscopic measuring instrument (STMT manufactured by Olympus Corporation). From the dimension in the MD direction and the dimension in the TD direction which are obtained by measurement, and the dimension (60 mm) of the hollow in the mold, mold shrinkage amount in the MD direction, mold shrinkage amount in the TD direction, and anisotropy of the molding shrinkage rate are calculated by Expressions 3 to 5 shown below. The results are shown in Tables 6 and 7.

Mold shrinkage amount in MD direction=Dimension of hollow of mold−dimension in MD direction Expression 3:

Mold shrinkage amount in TD direction=Dimension of hollow of mold−dimension in TD direction Expression 4:

Anisotropy of molding shrinkage rate=Mold shrinkage amount in TD direction/mold shrinkage amount in MD direction Expression 5:

TABLE 6

| | Molding condition | | Water | Anisotropy |
|---|---|---|---|---|
| | Cylinder | Mold | absorption | of molding |
| | temperature | temperature | warp amount | shrinkage |
| | (° C.) | (° C.) | (mm) | rate |
| Example 1 | 200 | 40 | 0.15 | 1.15 |
| Example 2 | 190 | 40 | 0.17 | 1.21 |
| Example 3 | 180 | 40 | 0.18 | 1.18 |
| Example 4 | 180 | 40 | 0.27 | 1.31 |
| Example 5 | 190 | 40 | 0.28 | 1.35 |
| Example 6 | 190 | 40 | 0.18 | 1.19 |
| Example 7 | 190 | 40 | 0.24 | 1.42 |
| Example 8 | 200 | 40 | 0.25 | 1.52 |
| Example 9 | 200 | 40 | 0.26 | 1.45 |
| Example 10 | 160 | 40 | 0.17 | 1.18 |
| Example 11 | 160 | 40 | 0.16 | 1.12 |
| Example 12 | 170 | 40 | 0.23 | 1.54 |
| Example 13 | 180 | 40 | 0.18 | 1.23 |
| Example 14 | 160 | 40 | 0.17 | 1.19 |
| Example 15 | 150 | 40 | 0.16 | 1.17 |
| Example 16 | 220 | 40 | 0.17 | 1.15 |
| Example 17 | 210 | 40 | 0.18 | 1.12 |
| Example 18 | 200 | 40 | 0.26 | 1.52 |
| Example 19 | 190 | 40 | 0.16 | 1.22 |
| Example 20 | 190 | 40 | 0.17 | 1.21 |
| Example 21 | 200 | 40 | 0.18 | 1.14 |
| Example 22 | 200 | 40 | 0.15 | 1.19 |
| Example 23 | 180 | 40 | 0.18 | 1.21 |

TABLE 7

| | Molding condition | | Water | Anisotropy |
|---|---|---|---|---|
| | Cylinder | Mold | absorption | of molding |
| | temperature | temperature | warp amount | shrinkage |
| | (° C.) | (° C.) | (mm) | rate |
| Comparative | 200 | 40 | 0.74 | 3.58 |
| Example 1 | | | | |
| Comparative | 170 | 40 | 0.55 | 4.52 |
| Example 2 | | | | |
| Comparative | 180 | 40 | 0.65 | 7.32 |
| Example 3 | | | | |
| Comparative | 160 | 40 | 0.61 | 10.85 |
| Example 4 | | | | |
| Comparative | 200 | 40 | 0.58 | 9.86 |
| Example 5 | | | | |
| Comparative | 205 | 40 | 0.68 | 8.88 |
| Example 6 | | | | |
| Comparative | 200 | 40 | 0.87 | 10.43 |
| Example 7 | | | | |
| Comparative | 200 | 40 | 0.84 | 9.85 |
| Example 8 | | | | |
| Comparative | 190 | 40 | 0.82 | 8.83 |
| Example 9 | | | | |
| Comparative | 190 | 40 | 0.88 | 9.85 |
| Example 10 | | | | |

### Example B

### Preparation of Pellets

Kneading is performed with a twin screw kneading apparatus (TEX41SS manufactured by Toshiba Machine Co., Ltd.) at mixing composition ratios and cylinder temperatures shown in Examples 24 to 26 shown in Table 8, so as to obtain resin composition pellets.

TABLE 8

| Composition ratio | | Kneading |
|---|---|---|
| Cellulose derivatives | Plasticizer | temperature |
| (parts by weight) | (parts by weight) | (° C.) |

| | | |
|---|---|---|
| Example 24 | Compound 7 (100) | 200 |
| Example 25 | Compound 8 (100) | 190 |
| Example 26 | Compound 9 (100) | 180 |

Injection Molding

With the obtained pellets, resin molded articles (length of 60 mm, width of 60 mm, and thickness of 2 mm) are prepared by using the injection molding machine (PNX40 manufactured by Nissei Plastic Industrial Co., Ltd.) under conditions of injection speed of 8 mm/s, maintaining pressure of 210 MPa, filling pressure of 120 MPa, injection time of 10 seconds, and cylinder temperatures and mold temperatures shown in Table 9.

Measurement of Water Absorption Warp Amount

In the same manner as the measurement of water absorption warp amount in Example A, D2 test specimens are prepared by using the obtained pellets, and water absorption warp amounts after the obtained D2 test specimens are maintained for 24 hours on an aluminum plate in the environment of temperature of 65° C. and humidity of 85% RH are obtained. The results are shown in Table 9.

Evaluation of Anisotropy of Molding Shrinkage Rate

With the resin molded articles obtained by injection molding, dimensions in the MD direction and the TD direction right after the molding (within 20 minutes after molding) are measured by a microscopic measuring instrument (STMT manufactured by Olympus Corporation). From the dimensions in the MD direction, the dimensions in the TD direction, and the dimension (60 mm) of the hollow in the mold which are obtained by measurement, anisotropy of the molding shrinkage rate is calculated in the same manner as in Example A. The results are shown in Table 9.

TABLE 9

| | Molding condition | | Water | Anisotropy |
|---|---|---|---|---|
| | Cylinder | Mold | absorption | of molding |
| | temperature | temperature | warp amount | shrinkage |
| | (° C.) | (° C.) | (mm) | rate |
| Example 24 | 200 | 40 | 0.15 | 2.3 |
| Example 25 | 190 | 40 | 0.17 | 2.9 |
| Example 26 | 180 | 40 | 0.18 | 2.45 |

From the results above, in the examples of which the water absorption warp amount is 0.3 mm or lower, it is found that anisotropy of the molding shrinkage rate is small, compared with that of the comparative examples.

In addition, in Example A in which the injection speed is in the range of 10 mm/s to 400 mm/s, and the maintaining pressure is in the range of 5 MPa to 200 MPa, anisotropy of the molding shrinkage rates in the obtained resin molded articles is small, compared with Example B in which the injection speed is less than 10 mm/s, and the maintaining pressure is greater than 200 MPa.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition comprising:
a cellulose derivative,
wherein a water absorption warp amount after a D2 test specimen obtained by injection-molding the resin composition using a mold of JIS type D2 regulated in JIS7152-3 (2005) is maintained for 24 hours on an aluminum plate in an environment of a temperature of 65° C. and a humidity of 85% RH is 0.3 mm or lower.

2. The resin composition according to claim 1,
wherein a weight average molecular weight of the cellulose derivative is in a range of 10,000 or greater and less than 75,000.

3. The resin composition according to claim 1,
wherein a weight average molecular weight of the cellulose derivative is in a range of 20,000 to 50,000.

4. The resin composition according to claim 1,
wherein the cellulose derivative is a cellulose derivative in which at least one hydroxyl group of cellulose is substituted with an acyl group, and
a substitution degree of the acyl group is in a range of 1.8 to 2.5.

5. The resin composition according to claim 2,
wherein the cellulose derivative is a cellulose derivative in which at least one hydroxyl group of cellulose is substituted with an acyl group, and
a substitution degree of the acyl group is in a range of 1.8 to 2.5.

6. The resin composition according to claim 3,
wherein the cellulose derivative is a cellulose derivative in which at least one hydroxyl group of cellulose is substituted with an acyl group, and
a substitution degree of the acyl group is in a range of 1.8 to 2.5.

7. The resin composition according to claim 4,
wherein the substitution degree of the acyl group in the cellulose derivative is in a range of 2 to 2.5.

8. The resin composition according to claim 5,
wherein the substitution degree of the acyl group in the cellulose derivative is in a range of 2 to 2.5.

9. The resin composition according to claim 6,
wherein the substitution degree of the acyl group in the cellulose derivative is in a range of 2 to 2.5.

10. The resin composition according to claim 4,
wherein the substitution degree of the acyl group in the cellulose derivative is in a range of 2.2 to 2.5.

11. The resin composition according to claim 5,
wherein the substitution degree of the acyl group in the cellulose derivative is in a range of 2.2 to 2.5.

12. The resin composition according to claim 6,
wherein the substitution degree of the acyl group in the cellulose derivative is in a range of 2.2 to 2.5.

13. The resin composition according to claim 1,
wherein a ratio occupied by the cellulose derivative with respect to a total amount of the resin composition is 70% by weight or greater.

14. The resin composition according to claim 2,
wherein a ratio occupied by the cellulose derivative with respect to a total amount of the resin composition is 70% by weight or greater.

15. The resin composition according to claim 4,
wherein a ratio occupied by the cellulose derivative with respect to a total amount of the resin composition is 70% by weight or greater.

16. The resin composition according to claim 7,
wherein a ratio occupied by the cellulose derivative with respect to a total amount of the resin composition is 70% by weight or greater.

17. The resin composition according to claim 10,
wherein a ratio occupied by the cellulose derivative with respect to a total amount of the resin composition is 70% by weight or greater.

18. A method of preparing a resin molded article, comprising:
injection-molding the resin composition according to claim 1 under conditions of an injection speed in a range of 10 mm/s to 400 mm/s and a maintaining pressure in a range of 5 MPa to 200 MPa, so as to obtain a resin molded article.

19. A resin molded article comprising a resin composition according to claim 1.

20. The resin molded article according to claim 19, which is molded by injection molding.
